(19) United States
(12) Patent Application Publication
(10) Pub. No.: US 2026/0164175 A1
(43) Pub. Date: Jun. 11, 2026

(54) SYSTEMS AND METHODS FACILITATING A PERSONALIZED AUDIO CONTENT DIRECTED TO AND FOLLOWING A USER VIA A SEQUENCE OF CONTINUOUS HANDOFFS AMONG MULTIPLE SPEAKERS

(71) Applicant: AT&T Intellectual Property I, L.P., Atlanta, GA (US)

(72) Inventors: James H. Pratt, Round Rock, TX (US); Inderpreet Singh Ahluwalia, Austin, TX (US); Gregory W. Edwards, Austin, TX (US); Eric Zavesky, Austin, TX (US)

(73) Assignee: AT&T Intellectual Property I, L.P., Atlanta, GA (US)

(21) Appl. No.: 18/972,056

(22) Filed: Dec. 6, 2024

(51) Int. Cl. H04R 3/12; G06F 3/16; H04W 4/029

(52) U.S. Cl. CPC H04R 3/12; G06F 3/165; H04W 4/029; H04R 2420/07

(57) ABSTRACT

Aspects of the subject disclosure may include, for example, facilitating personalized audio content directed to and following a user via a sequence of continuous handoffs among multiple audio devices in a user's environment by registering audio devices based on a location of a mobile device of the user, receiving a request for an audio stream from the mobile device, selecting an audio device near the mobile device's location, by tracking and updating the mobile device's location, updating the selection of the audio device, and handing off the audio stream to an updated audio device as the mobile device's location changes. Other embodiments are disclosed.

### FIELD OF THE DISCLOSURE

The subject disclosure relates to systems and methods facilitating a personalized audio content directed to and following a user via a sequence of continuous handoffs among multiple speakers in the user's environment.

### BACKGROUND

Existing audio delivery systems often require users to wear speakers to receive individually directed audio content while in motion. This approach can be cumbersome and inconvenient, particularly for senior citizens who may have difficulty managing wearable devices.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B illustrates an example, non-limiting embodiment of registration of speakers and users in accordance with various aspects described herein.

FIG. 2C is a block diagram illustrating another example, non-limiting embodiment of another system functioning within the communication network of FIG. 1 in accordance with various aspects described herein.

FIG. 2D depicts an illustrative embodiment of a method in accordance with various aspects described herein.

FIG. 2E depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods facilitating personalized audio content directed to and following a user via a sequence of continuous handoffs among multiple audio devices in a user's environment by registering audio devices based on a location of a mobile device of the user, receiving a request for an audio stream from the mobile device, selecting an audio device near the mobile device's location, by tracking and updating the mobile device's location, updating the selection of the audio device, and handing off the audio stream to an updated audio device as the mobile device's location changes. Other embodiments are described in the subject disclosure.

One or more aspects of the subject disclosure are directed to a non-transitory machine-readable medium, comprising executable instructions that, when executed by a processing system including a processor, facilitate performance of operations. The operations include registering one or more audio devices based on a location of a mobile device, wherein the one or more audio devices are communicatively connected with the mobile device and the mobile device is registered in association with a user; receiving a request for an audio stream from a mobile device; selecting, among the registered audio devices, an audio device that is proximate to the location of the mobile device at the time of receiving the request for the audio stream; tracking and updating the location of the mobile device; as the location of the mobile device is updated, updating the selection of the audio device; and when the selection of the audio device is updated, performing a sequence of continuous handoffs of the audio stream to an updated audio device such that the audio stream follows the updated location of the mobile device.

One or more aspects of the subject disclosure are directed to a method including steps of receiving, by a network node including a processor, a request for an audio stream from a user device; detecting, by the network node, proximity of the user device to a first location; identifying, by the network node, a first speaker in the vicinity of the first location, wherein the first speaker is communicatively connected with the user device; sending, by the network node, the audio stream to the first speaker for presentation to a user; tracking, by the network node, movement of the user device; detecting, by the network node, the movement of the user device to be proximate to a second location; identifying, by the network node, a second speaker in the vicinity of the second location, wherein the second speaker is communicatively connected with the user device; and handing off, by the network node, the audio stream to the second speaker for presentation to the user.

One or more aspects of the subject disclosure are directed to a system having a processing system including a processor and a memory that stores executable instructions that, when executed by the processing system, facilitate performance of operations. The operations include identifying one or more audio devices based on proximity to a location of a mobile device, wherein the one or more audio devices are communicatively connected with the mobile device; receiving a request for an audio stream from a mobile device; selecting, among the identified one or more audio devices, an audio device that is proximate to the location of the mobile device at the time of receiving the request for the audio stream; tracking and updating the location of the mobile device; based on the updated location of the mobile device, updating the selection of the audio device; and as the selection of the audio device is updated, performing a sequence of continuous handoffs of the audio stream to an updated audio device such that the audio stream follows the updated location of the mobile device.

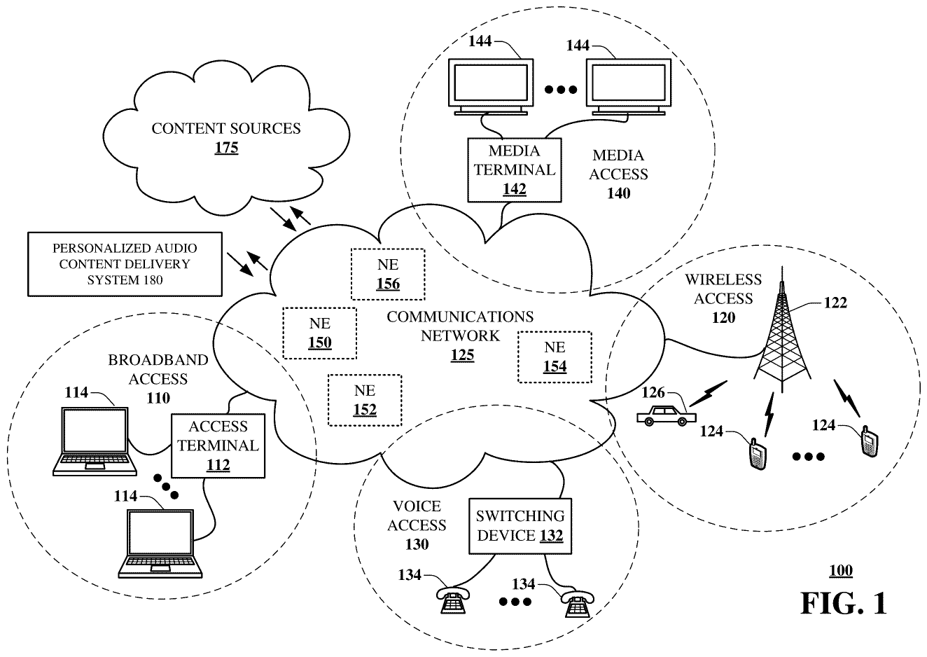

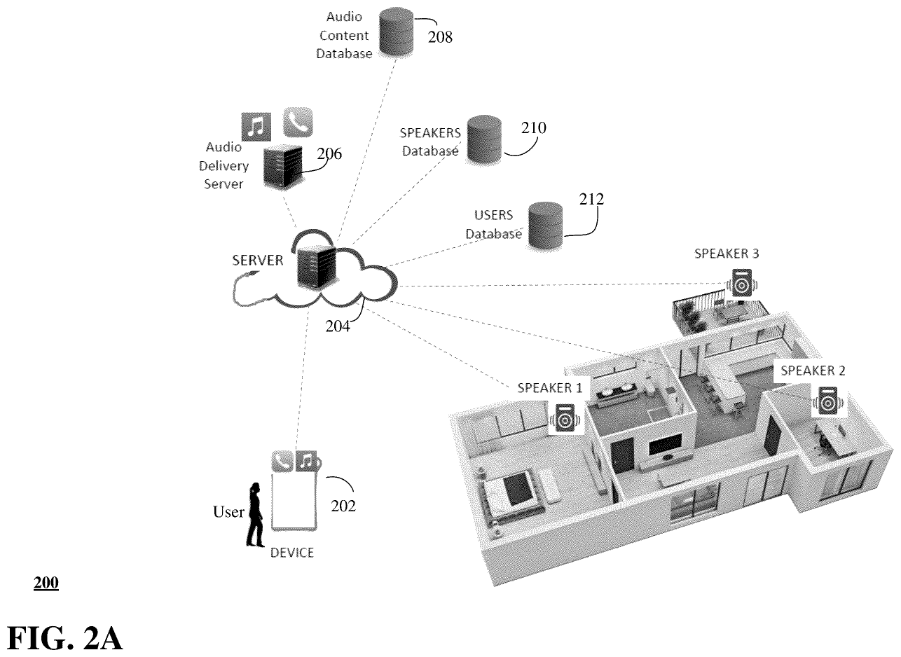

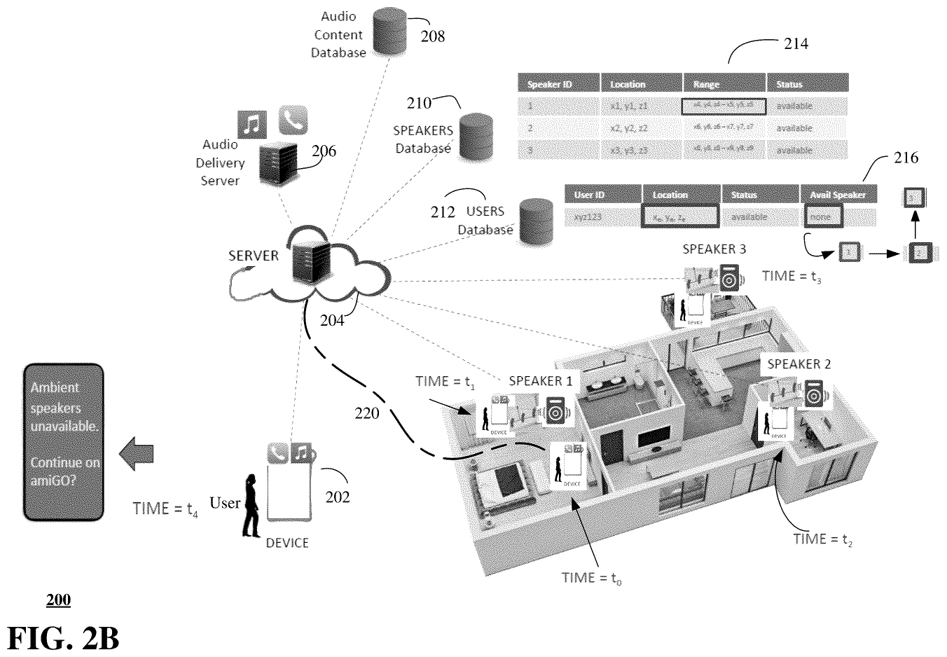

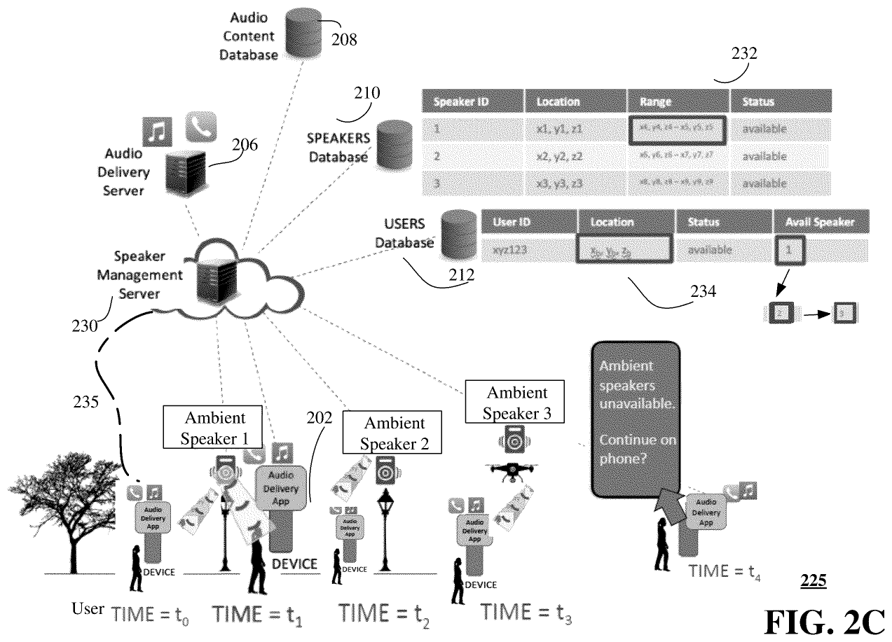

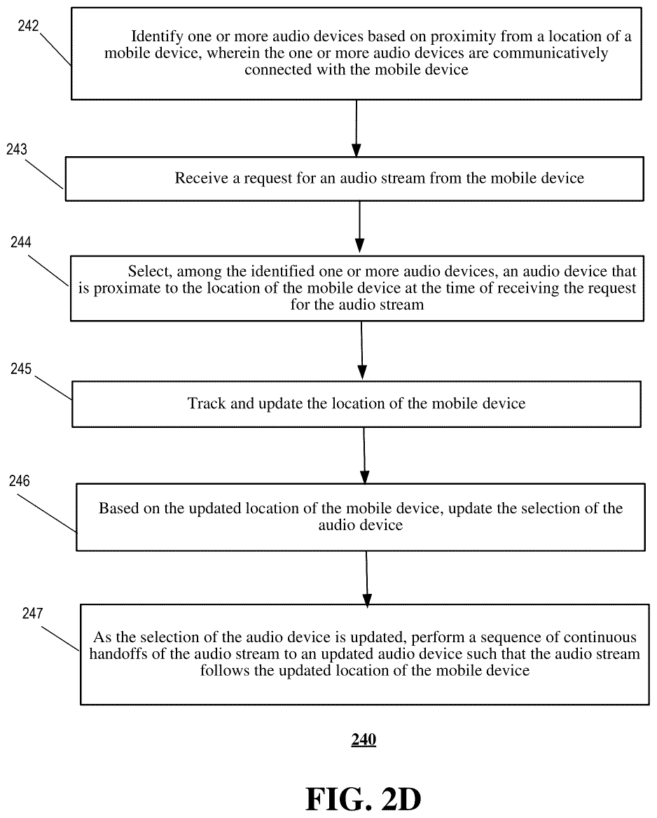

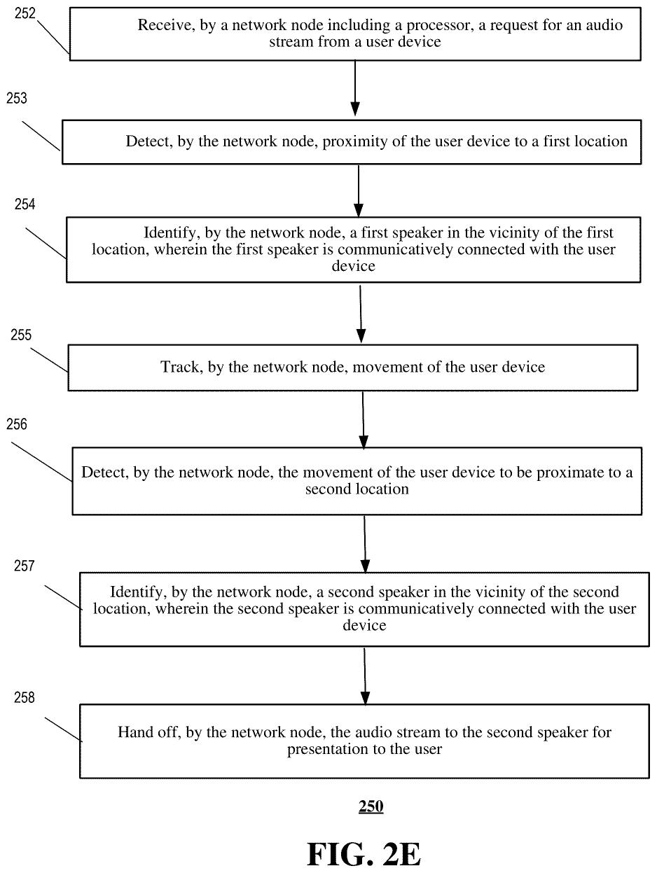

Referring now to FIG. 1, a block diagram is shown illustrating an example, non-limiting embodiment of a system 100 in accordance with various aspects described herein. For example, system 100 can facilitate in whole or in part systems and methods facilitating a personalized audio content directed to and following a user via a sequence of continuous handoffs among multiple speakers such as a personalized audio content delivery system 180, which will be described in detail below in connection with FIGS. 2A through 2E. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 2A is a block diagram illustrating an example, non-limiting embodiment of a system 200 functioning within the communication network of FIG. 1 in accordance with various aspects described herein.

Conventionally, wearable speakers are available as users move around within an area in order to receive individually directed audio content. The system 200 enables users to receive personalized audio streams delivered by a sequence of ambient speakers with the personalized audio streams following users as users move around. The system 200 is further enabled to deliver the personalized audio streams via a nearest speaker in a directional beam.

In various embodiments, the system 200 includes a user device 202, an audio device management server 204, an audio delivery server 206, an audio content database 208, a speakers database 210, and a users database 212. A user is equipped with the user device 202 which is a wireless device that is location aware. By way of example, the user device 202 can be a particular type of device that has subscribed to predetermined services. The user device 202 is equipped with one or more applications (“apps”) that are in communication with corresponding servers 204, 206, etc. These apps are of the nature that some form of audio is delivered between the audio delivery server 206 and an audio app in order to perform the functions of the audio app. For example, the audio delivery server 206 may be a music server, a voice communications server such as a phone app, and others.

As depicted in FIG. 2A, one or more networked speakers, such as Speaker 1, Speaker 2, and Speaker 3, are present in an user's personal environment such as a user's home, workplace, etc. that may have a known, fixed location, for instance smart speakers throughout the user's home. In some embodiments, the system 200 includes one or more audio devices such as one or more speakers positioned at different locations of a user's personal environment. The one or more speakers are registered with the audio device management server 204, and the registration includes a range of geographic coordinates that represent a current range to which the one or more speakers are able to broadcast audio. For example, the system 200 can register speakers located in different rooms of the user's home, each with a defined broadcast range.

In some embodiments, the system 200 includes one or more audio devices such as one or more ambient speakers positioned at different locations in a public space, wherein the one or more ambient speakers include a fixed speaker or a mobile speaker. For example, the system 200 can register both fixed speakers in public areas and mobile speakers that can move with the user.

In some embodiments, the system 200 includes a directional speaker operable to produce a beam of audio that is directed to a narrow range of a target destination that the directional speaker is engaged. The directional speaker is in communication with the audio delivery server 206 and the audio device management server 204 to receive instructions as to a direction to which to focus on the beam of audio. For example, the system 200 can use directional speakers that focus audio beams to specific locations based on instructions from the audio device management server 204.

FIG. 2B illustrates an example, non-limiting embodiment of registration of speakers and users. In various embodiments, when activated, each speaker, among Speakers 1, 2 and 3, sends a message to the audio device management server 204. The audio device management server 204 in turn registers each speaker in a speakers database 214. As depicted in FIG. 2B, the registration includes a unique ID for each speaker along with the speaker's location which was identified by the speaker and sent during the registration message. The registration also includes a range of geographic coordinates that represents the current range to which each speaker is able to broadcast audio.

In various embodiments, the speakers are directional speakers in that they produce a beam of audio that is directed to a narrow range of target destinations when they are engaged. The speakers are further directionally adjustable in that the direction of the beam is not only narrow but may be adjustable in that the speakers can be mounted on an axis and receive instructions from the server 204 as to the direction to which to focus on the beam.

As further depicted in FIG. 2B, the user's device 202 registers the user via the audio device management server 204 in the users database 212. A record for the user contains a unique ID for the user along with a current location for the user. This registration is continually updated such that the user's location is continually tracked in the users database 212. User's status, as it relates to audio delivery, is also registered in the users database 216. For example, if the user is available to receive audio and is not engaged in any other audio experience, the user is registered as available, as shown in FIG. 2B.

FIG. 2B further illustrates user proximity detection (shown as 220). At a point in time (Time=t₀), the user's proximity to one or more available speakers is determined, using the audio device management server 204, by comparing the user's location with the ranges of available speakers in the speakers database 210. For example, at time t₀, the user is in range of Speaker 1, as depicted in FIG. 2B. The users database 212 updates information such that an available speak data field indicates Speaker 1 from None.

At the same time t₀, a detection is made of audio that is intended for the user. This audio is pushed to the user, such as audio that is detected from a phone app such as an incoming call. In other cases, this audio is pulled from the audio delivery server 206, in response to a request that is sent from the user using the music app to receive audio from a music audio delivery server 206.

At a later time, t₁, the user's location may be updated, but the user may still be in the range of speaker 1, as depicted in FIG. 2B. As the user's location changes, as long as the user remains in the range of Speaker 1, the beam from Speaker 1 is adjusted such that its direction follows the user's location, as depicted in FIG. 2B.

In various embodiments, at a later time t₂, the user location is detected to be outside of the range of Speaker 1 but now within the range of Speaker 2. The audio device management server 204 instructs the audio delivery server 206 to redirect the audio stream to Speaker 2 and also instructs Speaker 1 to discontinue the audio stream and Speaker 2 to direct its audio beam to the direction of the location of the user. The users database 212 updates information such that the available speak data field indicates Speaker 2 from Speaker 1.

In various embodiments, at a time t₃, it is determined that another speaker is best located. The audio device management server 204 subsequently continually monitors the location of the user as it relates to other available speakers and, at a time at which a subsequent other available speaker is found, the server 204 instructs Speaker 2 to discontinue following the user and instruct the subsequent speaker (i.e., Speaker 3) to resume the audio stream. The users database 212 updates information such that the available speak data field indicates Speaker 3 from Speaker 2, as depicted in FIG. 2B.

In various embodiments, handing off from one speaker to another speaker, as the user's location changes, may be performed without disrupting playing of the audio stream. The user may not notice the handing off of speakers and the audio stream may be seamlessly and continuously played by different speakers. The speakers subject to the handing off may communicate with each other to ensure smooth transition therebetween. Prior to the handing off, the speakers may include information about the audio stream in play and other relevant information such as the user's location and the user's proximity to each speaker as the user is in motion, etc.

In various embodiments, at some point in time, t₄, it is determined that there is no match for an available speaker in the location of the user. In such a case, the user receives an alert from the audio device management server 204 that the audio stream cannot be delivered using ambient speakers but it can be redirected to the user's device. The user accepts the redirection offer and the audio device management server 204 subsequently instructs the audio delivery server to redirect the stream to an address associated with the user's device 202 as stored in the users database. Alternatively, the user need not be alerted and the audio transfer is transparent. The user may set up configurations or preferences to be stored in the users database 212 to make the audio transfer transparent.

In some embodiments, the audio device management server 204 may instruct the speakers to adjust the volume of the audio beam in relation to a distance between the speaker location and the user location. As the user proceeds further away from the speaker playing audio for the user at that time, for example, the audio device management server 204 detects this change in distance and instructs the speaker to raise the volume so as to compensate. In various embodiments, artificial intelligence/machine learning (AI/ML) techniques can be utilized for speakers to adjust the volume or learn user behaviors relating to operations of speakers. If the user had the ability to provide feedback to turn up the volume in a particular situation, speakers may learn a desired volume level for the user over time. Additionally, ambient noises such as opening a window, a car driving by, sirens from emergency vehicles, etc. can be detected and learned by speakers using AI/ML techniques to adjust volume.

In some embodiments, users may develop the same routine such as eating lunch in a kitchen at a determined time and play music. Speakers located in the kitchen and using AI/ML techniques may be prepared to play audio steam in light of users'pattern. Audio devices such as speakers may utilize AI/ML techniques to learn users'behavior or usage patterns and provide the personalized audio stream following users in context of users'behavior or usage patterns.

Additionally or alternatively, a calibration process may be run to check audio devices information in a relevant database and enable the audio device management server to check and identify a true range of audio devices. For instance, one speaker is the closest to the user but may be positioned behind a closed door, so another speaker positioned in an open space with the user, even though farther to the user than the one speaker, may be considered as the closest audio device. In determining the true range of audio devices, AI/ML techniques can be used. The audio device management server 204 may apply the true range of audio devices in determining and selecting proximity to the user, using AI/ML techniques. Audio devices, which may be put to use in different environments and use AI/ML techniques, may learn the true range based on feedback and selection by the user over time.

In another embodiment, the system 200 may include a set of speakers in one location and may be configured to play multiple streams for different users. This process may also be known as signal deconfliction, where multiple users require different solutions (e.g., audio streams) of the same system (e.g., a set of speakers). FIG. 2B depicts the same user moved to another position in the same space, and similarly, two users, a first user U1 and a second user U2, may be in the same space. Then the detection of the first user U1 and the second user U2 is first executed in the system 200. Utilizing AI/ML techniques learned above, the system 200 may then determine if each user is approaching, remaining still, or moving away from the speaker (e.g., Speaker 1 in FIG. 2B). With these two states determined, AI/ML techniques can then modulate an audio stream A1 directed to the first user U1 and an audio stream A2 directed to the second user U2 such that the audio stream is correctly adjusted and optimally heard for both users U1 and U2. Specifically, as known to persons having ordinary skill in the art of audio processing, phase inversion may be utilized to beam-form the audio stream A1 for the first user U1 only and the audio stream A2 for the second user U2 only. Phase inversion can be used to play an audio stream in a 180 degree out-of-phase state such that it cancels itself when meeting the original in-phase audio. While some spatial limitations may degrade a quality of a phase inversion solution (e.g. both user U1 and user U2 must be a minimum distance apart), the system 200 described herein is unique in its ability to produce discrete audio experiences of multiple streams for multiple users in the same space.

FIG. 2C is a block diagram illustrating another example, non-limiting embodiment of a system 225 functioning within the communication network of FIG. 1 in accordance with various aspects described herein. The system 225 enables users to receive personalized audio streams delivered by a sequence of ambient speakers.

In various embodiments, the system 200 includes the user device 202, a speaker management server 230, the audio delivery server 206, the audio content database 208, the speakers database 210, and the users database 212. A user is equipped with the user device 202 which is a wireless device that is location aware. The user device 202 is equipped with one or more applications (“apps”) that are in communication with corresponding servers 204, 206, etc. These apps are of the nature that some form of audio is delivered between the audio delivery server 206 and an audio app in order to perform the functions of the audio app. For example, the audio delivery server 206 may be a music server, a voice communications server such as a phone app, and others.

As depicted in FIG. 2C, one or more networked speakers, such as Ambient Speaker 1, Ambient Speaker 2, and Ambient Speaker 3, are present in an user's ambient environment. FIG. 2C also illustrates registration of ambient speakers and users. In various embodiments, when activated, each speaker, among Ambient Speakers 1, 2 and 3, sends a message to the speaker management server 230. The speaker management server 230 in turn registers each ambient speaker in a speakers database 232. As depicted in FIG. 2C, the registration includes a unique ID for each ambient speaker along with the speaker's location which was identified by the speaker and sent during the registration message. The registration also includes a range of geographic coordinates that represents the current range to which each ambient speaker is able to broadcast audio. Additionally, the ambient speakers are located in a public space and may be checked availability of the ambient speakers for an individual use. For instance, the user may be subscribed to using the ambient speakers arranged in certain public facilities or locations for a specific duration of time. Furthermore, mobile speakers owned by the user or available for a temporary rental or any other temporary uses can be used as the ambient speakers.

In various embodiments, the speakers are directional speakers in that they produce a beam of audio that is directed to a narrow range of target destinations when they are engaged. The speakers are further directionally adjustable in that the direction of the beam is not only narrow but may be adjustable in that the speakers can be mounted on an axis and receive instructions from the speaker management server 230 as to the direction to which to focus on the beam.

As further depicted in FIG. 2C, the user's device 202 registers the user via the speaker management server 230 in the users database 212. A record for the user contains a unique ID for the user along with a current location for the user. This registration is continually updated such that the user's location is continually tracked in the users database 212. User's status, as it relates to audio delivery, is also registered in the users database 216. For example, if the user is available to receive audio and is not engaged in any other audio experience, the user is registered as available, as shown in FIG. 2C.

FIG. 2C further illustrates user proximity detection (shown as 235). At a point in time (Time =t₀), the user's proximity to one or more available ambient speakers is determined by comparing the user's location with the ranges of available ambient speakers in the ambient speakers database 232. For example, at time t₀, the user is in range of Ambient Speaker 1, as depicted in FIG. 2C. The users database 212 updates information such that an available speak data field indicates Ambient Speaker 1.

At the same time t₀, a detection may be made of audio that is intended for the user. This audio may be pushed to the user, such as audio that is detected from a phone app such as an incoming call. In other cases, this audio may be pulled from the audio delivery server 206 in response to a request that is sent from the user using the music app to receive audio from the audio delivery server 206. There may also exist one or more networked speakers that have a known, fixed location. Additionally or alternatively, there may exist one or more speakers that are mobile, network enabled, and location aware.

In either case, the speaker management server 230 receives a message that audio is to be delivered to the user at time t₀. The speaker management server 230 sends a message to the audio delivery server 206 instructing it to direct the audio to the available ambient speaker, in this case, Ambient Speaker 1. The speaker management server 230 also sends a message to Ambient Speaker 1 indicating a direction to focus the audio beam such that it is directed to the location of the user, as depicted in FIG. 2C.

At a later time, t₁, the user's location may be updated, but the user may still be in the range of Ambient Speaker 1. As the user's location changes, as long as the user remains in the range of Ambient Speaker 1, the beam from Ambient Speaker 1 is adjusted such that its direction follows the user's location.

At a later time t₂, the user location may be detected to be outside of the range of Ambient Speaker 1 but now within the range of Ambient Speaker 2. The speaker management server 230 instructs the audio delivery server 206 to redirect the audio stream to Ambient Speaker 2 and also instructs Ambient Speaker 1 to discontinue the audio stream and Ambient speaker 2 to direct its audio beam to the direction of the location of the user. Handing off from Ambient Speaker 1 to Ambient speaker 2 may ensure that the audio stream is not affected and continuously and seamlessly played. The user may not notice the handing off between speakers. In some embodiments, speakers involved in the handing off process may communicate with each other and be loaded with information that facilitates and implements the continuous play of the audio stream.

At a time t₃, it may be determined that the available ambient speaker is a mobile speaker. An indication of the type of ambient speaker such as fixed or mobile may be included in the speakers database record 232. For a mobile speaker, the speaker management server 230 may send a message to the mobile speaker to instruct it to follow the user as they move about.

The speaker management server 230 may subsequently continually monitor the location of the user as it relates to other available ambient speakers and, at a time at which subsequent other available ambient speakers are found, the speaker management server 230 may instruct Ambient Speaker 3 to discontinue following the user and instruct the subsequent ambient speaker to resume the audio stream.

At some point in time, t₄, it may be determined that there is no match for an available ambient speaker in the location of the user. In such a case, the user may receive an alert from the speaker management server 230 that the audio stream cannot be delivered using ambient speakers but it may be redirected to the user's device. The user may accept the redirection offer and the speaker management server 230 may subsequently instruct the audio delivery server to redirect the stream to an address associated with the user's device as stored in the users database 212.

In some cases, it may be determined that an ambient speaker is available but that sending an audio beam via the system 225 described may not be desirable. For example, this may be the case if there are other people detected nearby the user who may be within range of the audio beam. The ambient speaker may be equipped with a sensor such as a motion sensor, camera, infrared sensor, or other that is directed in the same orientation as the intended audio beam direction. If the ambient speaker's sensor detects the presence of other people or other conditions within a potential range of an audio beam, the speaker management server 230 may instruct the audio delivery server 206 to send the audio directly to the user's device without use of an ambient speaker. In addition, if the ambient speaker may be available for an individual use in a public space, the speaker management server 230 may instruct the audio delivery server 206 to send the audio directly to the user's device.

In various embodiments, the speaker management server 230 may instruct the ambient speakers to adjust the volume of the audio beam in relation to a distance between the speaker location and the user location. As the user proceeds further away from an ambient speaker, for example, the speaker management server 230 may detect this change in distance and instruct the ambient speaker to raise the volume so as to compensate.

FIG. 2D depicts an illustrative embodiment of a method 240 in accordance with various aspects described herein. In various embodiments, FIG. 2D illustrates a method 240 for presenting an audio stream to a user in motion. The actions in this figure may be performed by the steps described in previous figures, such as the network node, audio delivery server, and user device.

At step 242, the method 240 identifies one or more audio devices based on proximity to a location of a mobile device. The one or more audio devices are communicatively connected with the mobile device. In some embodiments, step 242 involves determining the nearest audio devices to the mobile device. For example, the network node (e.g., the server 204) can use location data from the mobile device to identify nearby speakers registered in the speakers database. Additionally or alternatively, proximity to the location of the mobile device may include optimal proximity. For instance, a first audio device is the nearest to the location of the mobile device but positioned behind obstruction of sound. Then a second audio device in the same open space with the location of the mobile device may be considered to meet optimal proximity.

At step 243, the method 240 receives a request for an audio stream from the mobile device. In some embodiments, step 243 involves the user initiating a request for audio content. For example, the user may use an application on their mobile device to request a music stream from the audio delivery server.

At step 244, the method 240 selects an audio device that is proximate to the location of the mobile device at the time of receiving the request for the audio stream. In some embodiments, step 244 involves choosing the closest speaker to the mobile device. For example, the network node can select the speaker with the smallest distance to the mobile device from the speakers database. In some embodiments, at the time of receiving the request for the audio stream, a calibration process may take place to check audio devices such as speakers positioned and available in a particular environment of the user. The calibration process may check audio devices information in a relevant database and enable an audio device management server to check and identify a true range of audio devices. For instance, one speaker is the closest to the user but may be positioned behind a closed door, so another speaker positioned in an open space with the user, even though farther to the user than the one speaker, may be considered as the closest audio device.

At step 245, the method 240 tracks and updates the location of the mobile device. In some embodiments, step 245 involves continuously monitoring the mobile device's position. For example, the network node can use GPS or other location services to keep track of the mobile device's movements.

At step 246, based on the updated location of the mobile device, the method 240 updates the selection of the audio device. In some embodiments, step 246 involves re-evaluating which speaker is closest to the mobile device. For example, as the user moves, the network node (e.g., the server 204) can determine if a different speaker is now closer to the mobile device and update the selection accordingly.

At step 247, as the selection of the audio device is updated, the method 240 performs a sequence of continuous handoffs of the audio stream to an updated audio device such that the audio stream follows the updated location of the mobile device. In some embodiments, step 247 involves seamlessly transferring the audio stream from one speaker to another. For example, the network node (e.g., the server 204) can instruct a current speaker to stop playing the audio stream and a new speaker to start playing the audio stream, ensuring continuous audio delivery as the user moves.

In some embodiments, the method 240 includes registering one or more audio devices arranged in a private space of the user and registering one or more audio devices arranged in a public space of the user. For example, the system can register speakers located in the user's home as well as speakers located in public areas such as parks or shopping centers.

In some embodiments, the method 240 includes registering one or more audio devices arranged in a private space of the user and registering one or more audio devices arranged in a public space of the user. For example, the system can register speakers located in the user's home as well as speakers located in public areas such as parks or shopping centers.

In some embodiments, the method 240 includes determining that there is no match for an available audio device based on the updated location of the mobile device, transmitting to the mobile device an alert that the audio stream cannot be delivered using the registered one or more audio devices, and transmitting to the mobile device a message that the audio stream will be redirected to an address associated with the mobile device for play on the mobile device based on the determination that there is no match for the available audio device. For example, if the user moves to a location where no registered speakers are available, the system can alert the user and redirect the audio stream to the user's mobile device.

In some embodiments, the method 240 includes, while the audio stream is being played by a first audio device proximate to the mobile device, detecting that the location of the mobile device is within a range of the first audio device but a distance between the mobile device and the first audio device is changed, and commanding the first audio device to adjust a volume in response to the changed distance. For example, if the user moves further away from the first speaker, the system can command the speaker to increase the volume to maintain the audio level.

In some embodiments, the method 240 includes receiving, from one or more sensors included in the one or more audio devices, information indicating that playing of the audio stream is undesirable or needs to be stopped, and transmitting to the mobile device a message that the audio stream will be redirected to an address associated with the mobile device for play on the mobile device based on the receiving of the information that playing of the audio stream is undesirable or needs to be stopped. For example, if a sensor detects that there are other people nearby who might be disturbed by the audio, the system can redirect the audio stream to the user's mobile device.

In some embodiments, the method 240 includes detecting an event that matches with a transparent audio transfer event which is configured by the user and stored in a database specific to the user, and automatically redirecting the audio stream to an address associated with the mobile device for play on the mobile device. For example, if the user has configured the system to automatically transfer the audio stream to their mobile device when they leave their home, the system can detect this event and perform the transfer.

In some embodiments, the method 240 includes receiving the request for the audio stream from a customized application running on the mobile device, where the customized application is based on a subscription of service by the user to a personalized play of the audio stream using registered user information and registered audio devices information. For example, the user may use a subscription-based music application on their mobile device to request a personalized music stream, and the system delivers the requested stream using the registered speakers.

FIG. 2E depicts an illustrative embodiment of a method 250 in accordance with various aspects described herein. In various embodiments, the method 250 presents an audio stream to a user in motion. The actions in this figure may be performed by the steps described in previous figures, such as the network node, audio delivery server, and user device.

At step 252, the method 250 receives a request for an audio stream from a user device. In some embodiments, step 252 involves the user initiating a request for audio content. For example, the user may use an application on their mobile device to request a music stream from the audio delivery server.

At step 253, the method 250 detects proximity of the user device to a first location. In some embodiments, step 253 involves determining the location of the user device. For example, the network node can use GPS or other location services to identify the current location of the user device.

At step 254, the method 250 identifies a first speaker in the vicinity of the first location, wherein the first speaker is communicatively connected with the user device. In some embodiments, step 254 involves selecting the nearest speaker to the user device. For example, the network node can identify the closest speaker from the speakers database based on the location of the user device. Additionally or alternatively, proximity to the first location of the user device may include optimal proximity. For instance, a first audio device is the nearest to the location of the user device but positioned behind a closed door. Then a second audio device in the same open space with the location of the user device may be considered to meet optimal proximity.

At step 255, the method 250 tracks movement of the user device. In some embodiments, step 255 involves continuously monitoring the user device's position. For example, the network node can use GPS or other location services to keep track of the user device's movements.

At step 256, the method 250 detects the movement of the user device to be proximate to a second location. In some embodiments, step 256 involves identifying when the user device has moved to a new location. For example, the network node can determine that the user device is now closer to a different location based on updated location data.

At step 257, the method 250 identifies a second speaker in the vicinity of the second location, wherein the second speaker is communicatively connected with the user device. In some embodiments, step 257 involves selecting a new speaker that is now closest to the user device. For example, the network node can identify the second speaker from the speakers database based on the updated location of the user device.

At step 258, the method 250 hands off the audio stream to the second speaker for presentation to the user. In some embodiments, step 258 involves seamlessly transferring the audio stream from the first speaker to the second speaker. For example, the network node can instruct the first speaker to stop playing the audio stream and the second speaker to start playing the audio stream, ensuring continuous audio delivery as the user moves.

In some embodiments, the method 250 further includes detecting particular audio that is intended for the user while the audio stream is playing and pushing the particular audio to a speaker that is playing the audio stream at the time of the detection of the particular audio. The playing of the audio stream is temporarily paused. For example, if the user receives an incoming call while listening to music, the method 250 can detect the call and push the call audio to the current speaker, pausing the music stream until the call is completed.

In some embodiments, the method 250 further includes delivering the audio stream requested by using an application running on the user device from an audio delivery server. For example, the user may use a music application on their mobile device to request a music stream, and the audio delivery server delivers the requested music stream to the selected speaker.

In some embodiments, after the detection of the proximity of the user device to the first speaker, the method 250 further includes detecting the movement of the user device resulting in a different direction relative to the first speaker, updating the location of the user device, and sending a command to redirect the audio stream to follow the different direction. For example, if the user changes direction while moving, the system can update the user's location and redirect the audio stream to follow the new direction.

In some embodiments, the handing off of the audio stream in the method 250 further includes commanding an audio delivery server to discontinue the audio stream to the first speaker and redirect the audio stream to the second speaker. For example, when the user moves out of the range of the first speaker and into the range of the second speaker, the system can command the audio delivery server to stop the audio stream to the first speaker and start the audio stream to the second speaker.

In some embodiments, the method 250 further includes registering, in a speakers database, a first identifier (ID) and a first location of the first speaker, registering, in the speakers database, a second ID and a second location of the second speaker, and registering, in a users database, an ID of the user device, a location of the user device as a location of the user, a user's status indicative of availability of receiving the audio stream, and a speaker identifier in range of the location of the user. For example, the system can store information about the speakers and the user device in respective databases to facilitate the selection and handoff of audio streams.

In some embodiments, the method 250 further includes continually updating the location of the user device based on the tracked movement of the user device, and after the handing off of the audio stream, updating the speaker identifier in the users database from the first speaker to the second speaker. For example, as the user moves, the system can continuously update the user's location and the associated speaker identifier in the users database to ensure the audio stream is handed off to the appropriate speaker.

While for purposes of simplicity of explanation, the respective processes are shown and described as a series of blocks in FIGS. 2D-2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

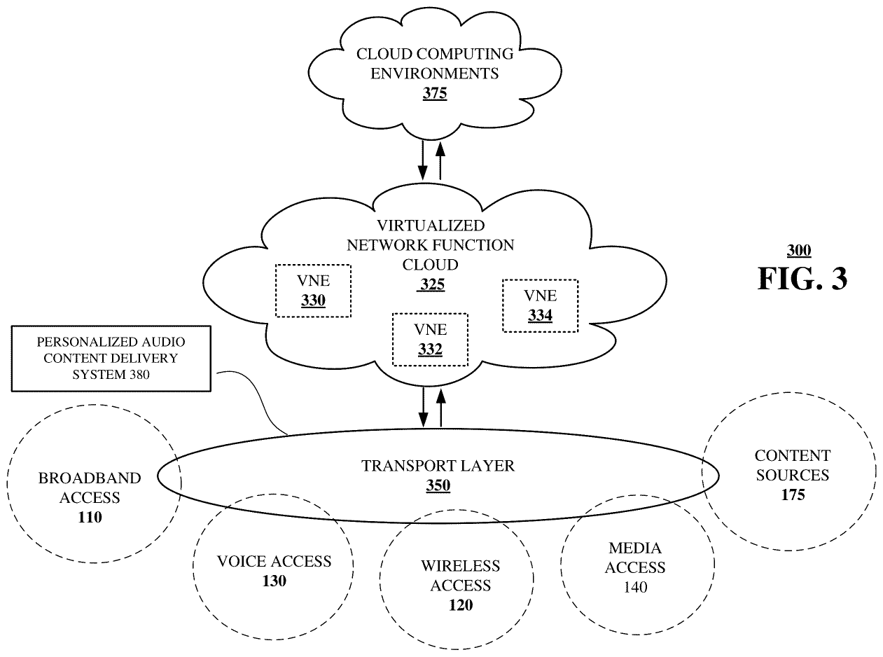

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part systems and methods facilitating a personalized audio content directed to and following a user via a sequence of continuous handoffs among multiple speakers such as a personalized audio content delivery system 380, which is described in detail above in connection with FIGS. 2A through 2E.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

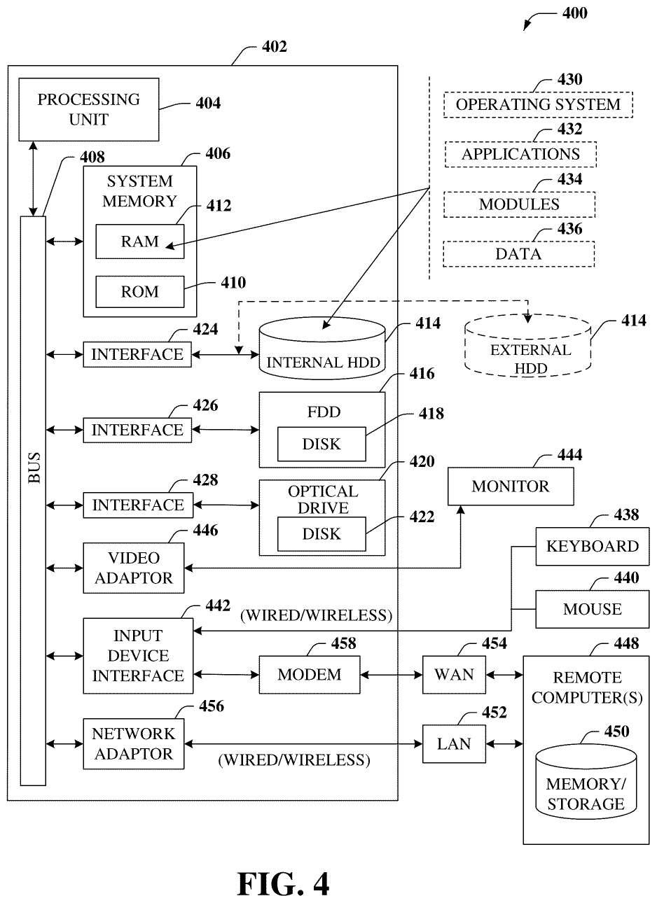

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods facilitating a personalized audio content directed to and following a user via a sequence of continuous handoffs among multiple speakers.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

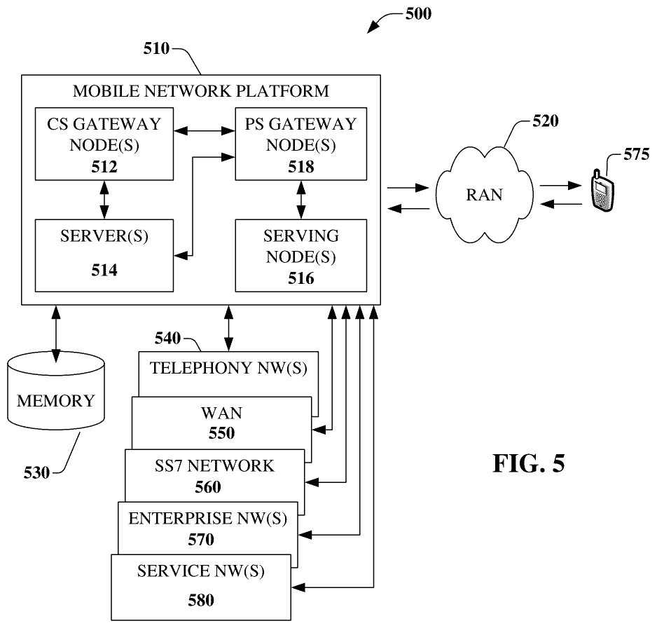

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods facilitating a personalized audio content directed to and following a user via a sequence of continuous handoffs among multiple speakers. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

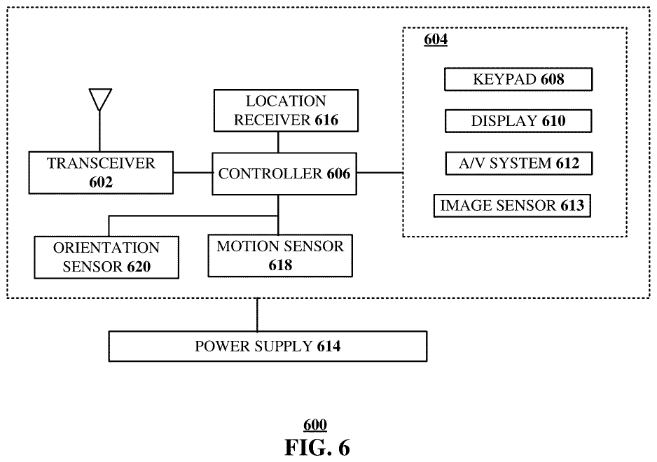

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods facilitating a personalized audio content directed to and following a user via a sequence of continuous handoffs among multiple speakers.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth®Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A non-transitory machine-readable medium, comprising executable instructions that, when executed by a processing system including a processor, facilitate performance of operations, the operations comprising:
registering one or more audio devices based on a location of a mobile device, wherein the one or more audio devices are communicatively connected with the mobile device and the mobile device is registered in association with a user;
receiving a request for an audio stream from the mobile device;
selecting, among the registered audio devices, an audio device that is proximate to the location of the mobile device at the time of receiving the request for the audio stream;
tracking and updating the location of the mobile device;
as the location of the mobile device is updated, updating the selection of the audio device; and
when the selection of the audio device is updated, performing a sequence of continuous handoffs of the audio stream to an updated audio device such that the audio stream follows the updated location of the mobile device.

2. The non-transitory machine-readable medium of claim 1, wherein the registering of one or more audio devices further comprises:
registering the one or more audio devices arranged in a private space of the user; and
registering the one or more audio devices arranged in a public space of the user.

3. The non-transitory machine-readable medium of claim 1, wherein the updating the selection of the audio device further comprise:
determining that there is no match for an available audio device based on the updated location of the mobile device;
transmitting, to the mobile device, an alert that the audio stream cannot be delivered using the registered one or more audio devices; and
transmitting, to the mobile device, a message that the audio stream will be redirected to an address associated with the mobile device for play on the mobile device based on the determination that there is no match for the available audio device.

4. The non-transitory machine-readable medium of claim 1, wherein the operations further comprise:
while the audio stream is being played by a first audio device proximate to the mobile device, detecting that the location of the mobile device is within a range of the first audio device but a distance between the mobile device and the first audio device is changed; and
commanding the first audio device to adjust a volume in response to the changed distance.

5. The non-transitory machine-readable medium of claim 1, wherein the operations further comprise:
receiving, from one or more sensors included in the one or more audio devices, information indicating that playing of the audio stream is undesirable or needs to be stopped; and
transmitting, to the mobile device, a message that the audio stream will be redirected to an address associated with the mobile device for play on the mobile device based on the receiving of the information that playing of the audio stream is undesirable or needs to be stopped.

6. The non-transitory machine-readable medium of claim 1, wherein the operations further comprise:
detecting an event that matches with a transparent audio transfer event which is configured by the user and stored in a database specific to the user; and
automatically redirecting the audio stream to an address associated with the mobile device for play on the mobile device.

7. The non-transitory machine-readable medium of claim 1, wherein the receiving of the request for the audio stream from the mobile device further comprise receiving the request for the audio stream from a customized application running on the mobile device, wherein the customized application is based on a subscription of service by the user to a personalized play of the audio stream using registered user information and registered audio devices information.

8. A method, comprising:
receiving, by a network node including a processor, a request for an audio stream from a user device;
detecting, by the network node, proximity of the user device to a first location;
identifying, by the network node, a first speaker in the vicinity of the first location, wherein the first speaker is communicatively connected with the user device;
sending, by the network node, the audio stream to the first speaker for presentation to a user;
tracking, by the network node, movement of the user device;
detecting, by the network node, the movement of the user device to be proximate to a second location;
identifying, by the network node, a second speaker in the vicinity of the second location, wherein the second speaker is communicatively connected with the user device; and
handing off, by the network node, the audio stream to the second speaker for presentation to the user.

9. The method of claim 8, comprising:
detecting, by the network node, particular audio that is intended for the user, while the audio stream is playing; and
pushing, by the network node, the particular audio to a speaker that is playing the audio stream at the time of the detection of the particular audio, wherein the playing of the audio stream is temporarily paused.

10. The method of claim 8, comprising:
delivering, by the network node, from an audio delivery server, the audio stream requested by using an application running on the user device.

11. The method of claim 8, comprising:
after the detection of the proximity of the user device to the first speaker, detecting, by the network node, the movement of the user device resulting in a different direction relative to the first speaker; and
updating, by the network node, a location of the user device; and
sending, by the network node, a command to redirect the audio stream to be directed to and follow the different direction.

12. The method of claim 8, wherein the handing off of the audio stream further comprises commanding, by the network node, an audio delivery server to discontinue the audio stream to the first speaker and redirect the audio stream to the second speaker.

13. The method of claim 8, comprising:
registering, by the network node, in a speakers database, a first identifier (ID) and a first location of the first speaker;
registering, by the network node, in the speakers database, a second ID and a second location of the second speaker; and
registering, by the network node, in a users database, an ID of the user device, a location of the user device as a location of the user, a user's status indicative of availability of receiving the audio stream, and a speaker identifier in range of the location of the user.

14. The method of claim 13, comprising:
continually updating, by the network node, the location of the user device based on the tracked movement of the user device; and
after the handing off of the audio stream, updating, by the network node, the speaker identifier in the users database, from the first speaker to the second speaker.

15. A system, comprising:
a processing system including a processor; and
a memory that stores executable instructions that, when executed by the processing system, facilitate performance of operations, the operations comprising:
identifying one or more audio devices based on proximity to a location of a mobile device, wherein the one or more audio devices are communicatively connected with the mobile device;
receiving a request for an audio stream from the mobile device;
selecting, among the identified one or more audio devices, an audio device that is proximate to the location of the mobile device at the time of receiving the request for the audio stream;
tracking and updating the location of the mobile device;
based on the updated location of the mobile device, updating the selection of the audio device; and
as the selection of the audio device is updated, performing a sequence of continuous handoffs of the audio stream to an updated audio device such that the audio stream follows the updated location of the mobile device.

16. The system of claim 15, wherein the one or more audio devices further comprise one or more speakers positioned at different locations of a user's personal environment, wherein the one or more speakers are registered with an audio device management server, and wherein the registration includes a range of geographic coordinates that represents a current range to which the one or mor speakers are able to broadcast the audio stream.

17. The system of claim 15, wherein the one or more audio devices further comprise one or more ambient speakers positioned at different locations in a public space, wherein the one or more ambient speakers include a fixed speaker and a mobile speaker.

18. The system of claim 15, wherein the one or more audio devices further comprise a directional speaker operable to produce a beam of audio that is directed to a narrow range of a target destination that the directional speaker is engaged, wherein the directional speaker is in communication with an audio delivery server and an audio device management server to receive instructions as to a direction on which the beam of audio focuses.

19. The system of claim 15, wherein the operations further comprise:
determining that there is no match for an available audio device based on the updated location of the mobile device; and
transmitting, to the mobile device, an alert that the audio stream cannot be delivered using the identified one or more audio devices.

20. The system of claim 19, wherein the operations further comprise:
transmitting, to the mobile device, a message that the audio stream will be redirected to an address associated with the mobile device for play on the mobile device based on the determination that there is no match for the available audio device; and
storing, in a user database, a configuration that activates transparent audio transfer to the mobile device based on the determination that there is no match for the available audio device.
